(19) United States
(12) Patent Application Publication
(10) Pub. No.: US 2006/0071052 A1
(43) Pub. Date: Apr. 6, 2006

(54) Method and apparatus for determining solder paste composition quality

(76) Inventors: Peter Conlon, Lucan (IE); James Mahon, Glasnevini (IE)

Correspondence Address: PERMAN & GREEN, 425 POST ROAD, FAIRFIELD, CT, 06824, US

(21) Appl. No.: 11/240,061

(22) Filed: Sep. 30, 2005

(30) Foreign Application Priority Data
Sep. 30, 2004 (GB) 0421688.3

(51) Int. Cl. B23K 31/12

(52) U.S. Cl. 228/103

(57) ABSTRACT

Determining the quality of a solder paste deposit includes comparing the fluorescence from a solder paste deposit with that of a deposit having an ideal mixture of flux and metal spheres.

### CROSS-REFERENCE TO RELATED APPLICATIONS

This application claims priority from British Patent Application No. 0421688.3, filed on Sep. 30, 2004.

The present invention relates to a method for determining solder paste composition. Furthermore the present invention relates to an apparatus for determining the quality of solder paste composition.

### BACKGROUND

Solder paste is a tacky substance containing small metal spheres typically 15-30 um in diameter, which are held in suspension in an organic viscous fluid commonly known as flux. The paste is sufficiently fluid so as to allow screen-printing onto substrates, such as printed circuit boards (PCB). The printing thickness is typically 80-200 microns and the printed deposits can have areas as low as 0.250 mm². After printing, components are placed on the substrate with their electrical contacts or pins embedded into the paste. The substrate is then heated beyond the melting temperature of the paste causing the paste to reflow and thereby allowing an electrically conductive metallic joint to be formed between the component's pin and the substrate. The assembly is then allowed to cool thereby solidifying the solder paste and fixing the component in place on the substrate. As well as being required to retain the paste solder balls in suspension, flux performs the important task of ensuring that the pad surface and the component pin are free from contamination thereby promoting the formation of a good solder joint. Typically during the reflow process the flux component of the solder paste evaporates.

Many factors can contribute to the quality of the joint formed between the component's pins and the solder paste track printed onto the substrate. One of these known factors relates to the composition of the solder paste, in particular the homogeneity of the composition. A situation may exist where a paste deposit is actually composed of more flux than metal spheres. In this case the viability of the joint formed with the component may be compromised due to the low metal content in the solder paste. This technical problem is illustrated in FIGS. 1a-c. FIG. 1a shows a diagram of a substrate 10 having three individual deposits of solder paste 12, 13 and 14 disposed on the surface of the substrate. Deposits 12 and 13 have, for example, the correct proportion of metal spheres and flux making up the solder paste. However, deposit 14, for example, has a higher concentration of flux in the paste mixture. As seen in FIG. 1b components 22, 23 and 24 are placed on top of deposits 12, 13 and 14 respectively, the next step as illustrated in FIG. 1c is where reflow occurs. As previously stated this is the result of heating the substrate to a temperature which allows the solder paste to become fluid again. If the correct mixture of metal spheres and flux is used in the paste a good joint is established between the component and the deposit as seen with deposits 12 and 13. However, if an incorrect mixture of metal spheres and flux in the solder paste is used as seen with deposit 14 a bad or insufficient joint is established between the component and the deposit. This ultimately leads to poor electrical contact between the substrate and the component and the incorrect or complete failure of the circuit to which the component belongs.

In modern manufacturing processes typically used with surface mount technology components some form of optical inspection will be present on the production line. Solder paste can be inspected using two distinct known methods namely 2D where the area X and Y offset, stencil theta, and deposit area are measured, and 3D where the area X and Y offset, stencil theta, height, area and volume are measured. However, these methods determine the profile of the paste deposit and are not able to determine whether the solder paste has the correct flux content. This is due to the fact that the profile of solder paste deposits with high flux content is the same or very similar to deposits with the correct metal spheres and flux mixture in the paste. Thus neither existing optical inspection method is capable of detecting either high or low flux content in solder paste deposits.

It is known that flux is an organic compound and as such will fluoresce when exposed to ultraviolet (UV) light of sufficient intensity and of the correct wavelength. European patent No. 1175276 B1 teaches us that a deposited volume of flux without any solder balls is directly proportional to the intensity of the fluorescent light given off by the deposit. However, this application fails to teach us that the mixed quality of the paste, namely flux plus solder content can also be determined by measuring the fluorescence of the deposit with the use of UV light.

### SUMMARY OF THE INVENTION

It is an object of the present invention to provide both a method and apparatus for determining via the use of UV induced fluorescence whether or not a solder paste deposit has the correct composition of metal spheres and flux.

According to the present invention there is provided a method for determining the quality of a solder paste deposit comprising the steps of illuminating the solder paste deposit with a light source, the light source being arranged to emit excitation radiation at a wavelength which causes the deposit to fluoresce, measuring the emitted fluorescence radiation intensity, calculating the density of flux present in the solder paste deposit by comparing the measured fluorescence radiation intensity with a predetermined intensity value, the predetermined intensity value being indicative of a target flux density, thereby indicating the quality of the solder paste deposit.

Furthermore, according to the present invention there is provided apparatus for determining the quality of a solder paste deposit comprising a light source arranged to illuminate a solder paste deposit, the light source being arranged to emit excitation radiation at a wavelength which causes the solder paste deposit to fluoresce, a detector arranged to measure the emitted fluorescence radiation intensity, means for calculating the density of flux present in the solder paste deposit by comparing the measured fluorescence radiation intensity with a predetermined intensity value, the predetermined intensity value being indicative of a target flux density, thereby indicating the quality of the solder paste deposit.

Advantageously the present invention allows for online inspection of substrates, in particular printed circuit boards, having solder paste printed thereon and for determining whether or not the composition of the solder paste is sufficient such that during reflow a sufficient joint can be established between the component pins and the substrate. Such a method and apparatus will both improve the yield of a production line which employs these methods and or apparatus and ultimately increase the reliability of circuits made using substrates having undergone the inspection method of the present invention.

It is know that flux evaporates when exposed to the atmosphere and thus the solder paste has a limited shelf life once removed from its container and exposed to the atmosphere. This means that even though the solder paste may be mixed with the correct concentration of flux and metal spheres initially, it may nevertheless not have enough flux present during the reflow process to establish a sufficient electrical contact between the component pins and the substrate. Thus the method and apparatus of the present invention may also advantageously be used to determine when a solder paste has been exposed to atmosphere for too long a period of time. For example, should the intensity of the UV induced fluorescence fall below a certain threshold this may cause a error signal to be generated indicating that the solder paste no longer has sufficient amount of flux present in its mixture to establish sufficient contact during the reflow process.

Furthermore, the measured fluorescence can be used to determine the homogeneity of the paste. For example a solder paste that comprises a high flux component will fluoresce more than a solder paste with low flux content. Similarly a low fluorescence signal will indicate that the solder paste deposit has a lower concentration of flux.

### BRIEF DESCRIPTION OF THE DRAWINGS

While the principal advantages and features of the present invention have been described above, a greater understanding and appreciation will be obtained by referring to the drawings and detailed description which follow where:

FIGS. 1a-1c show individual solder paste deposits with different characteristics;

FIG. 2 illustrates an embodiment of the apparatus used according to the present invention, and

FIG. 3 illustrates the steps according to the method of the present invention.

### DETAILED DESCRIPTION OF THE PREFERRED EMBODIMENTS

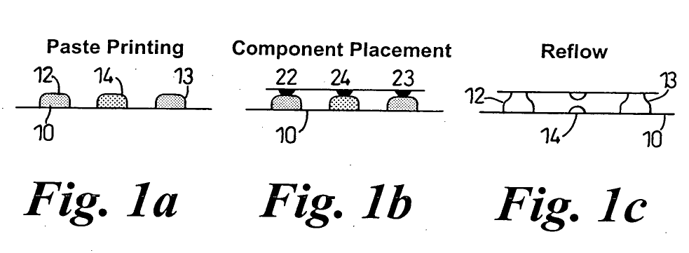

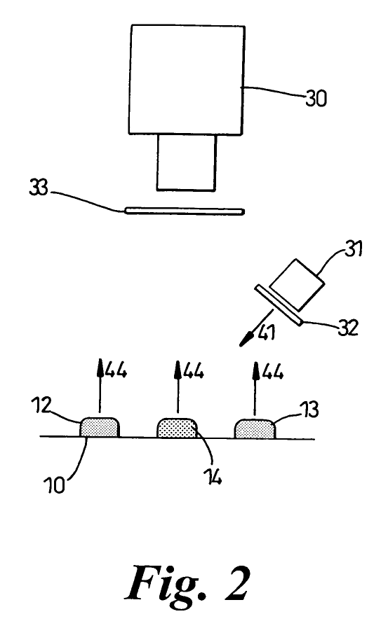

As can be seen in FIG. 2 where parts also appearing in FIG. 1 bear identical numerical designation, the apparatus of the present invention comprises a light source 31, which is arranged to illuminate deposits 12, 13 and 14 disposed on substrate 10 with radiation 41. The light source for the purposes of this example is a UV light source. The UV light source will typically emit radiation in the 350-400 nm range. A filter 32 is placed in front of the UV light source. The purpose of the filter is to filter out visible light thus ensuring only UV light of the appropriate wavelength (360-380 nm range), typically 370 nm, is incident upon the deposits 12, 13 and 14. The fluorescence will be proportional to the amount of flux present. The UV light source may be comprised of LEDs and may be incorporated in a standard lighting head. The light source may also be arranged in a ring around the deposit in order to improve illumination of the deposit so that the emitted fluorescence radiation can be measured at regions across the solder paste deposit independent of the illumination angle. The light source can be designed so that is can be retrofitted to existing apparatus.

The fluorescence from the deposits will be emitted towards the camera lens assembly 30 located above the substrate. A UV blocking filter 33 may be placed in front of the camera lens assembly in order to insure that the camera lens assembly detects only radiation from the fluorescing solder paste deposit and not visible light reflections from the surrounding exposed copper.

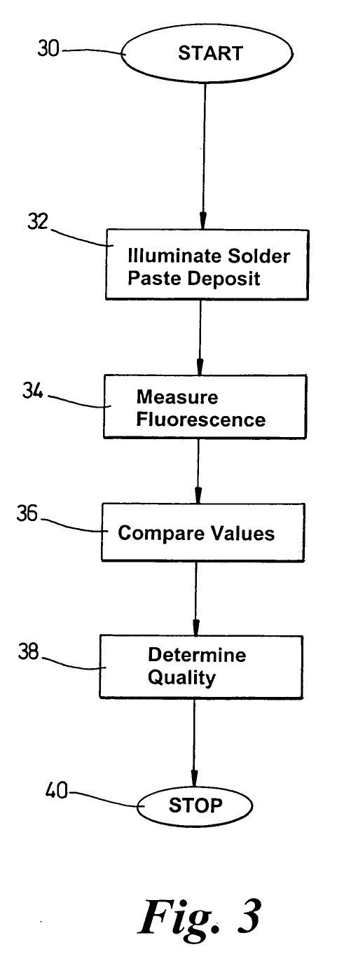

It is envisioned that the method and apparatus of the present invention could be used in conjunction with other known optical inspection techniques. For example, the volume of the solder paste can be determined using known optical techniques followed by the measurement of the amount of flux in the solder paste as described in the present invention. Alternatively the area of the solder paste could be measured followed by the measurement of the volume of flux present in the solder paste. Or finally the amount of solder flux present in the solder paste could be determined on its own as described by the steps shown in FIG. 3.

The method begins 30 by illuminating the solder paste deposit 32 with the UV light source. Fluorescence from the deposit is them measured 34 and this value is compared with a target value 36. Determining if a given deposit has failed may be done in a number of different ways. For instance the average fluorescence may be taken and compared against the pass-fail threshold. Alternatively a measure of deposit density may be taken (by analysing the distribution of fluorescence across the deposit).

It may be the case that the average flux fluorescence may be below the pass-fail threshold but that the flux density may be sufficient to promote a good joint. In this case the deposit will pass. From this comparison the quality of the solder paste deposit is determined 38 and the process ends 40.

It is not intended that the present invention be limited to the above embodiments and other modifications and variations are envisioned within the scope of the claims.

What is claimed is:

1. A method for determining the quality of a solder paste deposit comprising the steps of:
illuminating the solder paste deposit with a light source, the light source being arranged to emit excitation radiation at a wavelength which causes the deposit to fluoresce,
measuring the emitted fluorescence radiation intensity,
calculating the density of flux present in the solder paste deposit by comparing the measured fluorescence radiation intensity with a predetermined intensity value, the predetermined intensity value being indicative of a target flux density, thereby indicating the quality of the solder paste deposit.

2. The method of claim 1, wherein the emitted fluorescence radiation intensity is measured at regions across the solder paste deposit independent of illumination angle.

3. The method of claim 1, wherein the predetermined intensity value indicates a flux intensity threshold.

4. The method of claim 1, wherein the excitation radiation is in the range of 350 nm to 400 nm.

5. A method of inspecting a printed circuit board comprising the steps as claimed in claim 1.

6. An apparatus for determining the quality of a solder paste deposit comprising:
a light source arranged to illuminate a solder paste deposit, the light source being arranged to emit excitation radiation at a wavelength which cause s the solder paste deposit to fluoresce,
a detector arranged to measure the emitted fluorescence radiation intensity, means for calculating the density of flux present in the solder paste deposit by comparing the measured fluorescence radiation intensity with a predetermined intensity value, the predetermined intensity value being indicative of a target flux density, thereby indicating the quality of the solder paste deposit.

7. Apparatus as claimed in claim 6, wherein the light source is a UV light source.

8. Apparatus as claimed in claim 7, wherein the UV light source emits radiation in the 350 nm to 400 nm wavelength range.

9. Apparatus as claimed in claim 6, wherein the light source is arranged in a ring around the solder paste deposit.

10. Apparatus as claimed in claim 6, wherein a filter is disposed in front of the light source, the filter being configured to transmit UV radiation.

11. Apparatus as claimed in claim 10, wherein the filter transmits radiation at 370 nm.

12. Apparatus as claimed in claim 6, wherein a further filter is disposed in front of the detector, the further filter being configured to transmit emitted fluorescence radiation.

13. Apparatus as claimed in claim 12, wherein the further filter transmits radiation in the 400 nm to 550 nm wavelength range.

14. Apparatus as claimed in claim 6, wherein the light source is attachable to an existing lighting head as a retrofitted object.
